(19) United States
(12) Patent Application Publication
(10) Pub. No.: US 2016/0097965 A1
(43) Pub. Date: Apr. 7, 2016

(54) STAND STYLE REAR LENS CAP

(71) Applicant: Chung-Chien LIN, Keelung (TW)

(72) Inventor: Chung-Chien LIN, Keelung (TW)

(21) Appl. No.: 14/504,390

(22) Filed: Oct. 1, 2014

(51) Int. Cl. G03B 11/04

(52) U.S. Cl. CPC G03B 11/041

(57) ABSTRACT

A stand style rear lens cap for use in a detachable lens of a camera is disclosed. The stand style rear lens cap includes a stand body having an upper end including a horizontal plane, and the horizontal plane having a central opening adapted for a rear-end projection of the detachable lens to pass therethrough, wherein a first diameter of the central opening is smaller than a second diameter of a lens body distal end of the detachable lens, a first depth of the central opening is larger than or equal to a height of the rear-end projection of the detachable lens, and an inner wall of the central opening is provided with a component that correspondingly engages with the rear-end projection of the detachable lens.

### FIELD

The present invention relates to a rear lens cap for a camera lens, and more particularly, to a stand style rear lens cap for a detachable lens of a camera.

### BACKGROUND

The rear lens cap has been a big headache for the user in the process of replacing a conventional camera lens. In order to protect the rear piece of the lens from being exposed to scratching and dusts, the lens detached during the replacement operation must be firstly covered by the rear lens cap that has been previously removed and then a lens to be installed is removed; and meanwhile, the rear lens cap that has been unscrewed must be placed at an appropriate place (to prevent exposure to dusts or failure to find the rear lens cap after a while) before putting the lens on the camera body.

In the aforesaid process of replacing the camera lens, putting on and unscrewing the lens cap both require the use of both hands: the lens body is held by one hand while the lens cover is screwed by the other hand. This causes the camera body hung on the user's body to swing, and in such situations, it is very likely that the camera body is damaged due to accidental collision with the lens held by the hand or with other things.

Moreover, the photosensitive elements and the rear piece of the replaced lens, which are the most important elements for the modern digital cameras, are both exposed to the outside in the process of replacing the lens. The longer the time taken to replace the lens is, the higher the possibility that the photosensitive elements and the lens are stained by dusts will be and, also, the probability of missing capture of an important picture will be. Therefore, the inconveniences in replacing the lens is one of the important reasons that many consumers do not like to use cameras with replaceable lenses.

Accordingly, how to provide a stand style rear lens cover to shorten the time necessary for replacing a detachable lens of a camera and to improve the safety in replacing the detachable lens is currently one of the important problems to be overcome.

### SUMMARY

In order to solve the problem that the conventional rear lens cap causes problems when the lens is replaced, the stand style rear lens cap of the present invention includes the rear lens cap and the stand that supports the lens body integrated together so that it can be joined with the lens through a very simple mechanism. Then, by appropriately setting the size of the stand that supports the lens body, the lens together with the stand can be placed to the bottom of a partition in a camera backpack so as to be fixed there. Meanwhile, by means of the supporting force that sticks the stand to the bottom, the user can intuitively remove the lens from or put the lens back to the stand directly and quickly with a single hand while the camera body is held stably by the other hand so that the new lens can be installed at the quickest speed after the original lens is detached. Thereby, the operation of replacing the lens that has been troublesome can become easy, quick and safe.

Even when being used in other places than in the camera backpack, the stand style rear lens cap of the present invention can make the operation of replacing the lens quicker and more convenient than the conventional way of replacing the rear piece of the lens. The main reason is that, it is unnecessary to hold the lens with one hand and unscrew or screw the rear lens cap with the other hand and to find a place for placing the rear lens cap or retrieve it from the place; and instead, the user can remove and put back the lens directly without having to move. Therefore, the stand style rear lens cap of the present invention can be used to completely replace the conventional rear lens cap.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic structural view illustrating how a stand style rear lens cap engages with a detachable lens according to the present invention;

FIG. 2 is a schematic view illustrating how to use the stand style rear lens cap and the detachable lens that are placed in a camera backpack;

FIG. 3 is a schematic structural view illustrating a mechanism 1 through which the stand style rear lens cap engages with the detachable lens according to the present invention;

FIG. 4 is a schematic structural view illustrating a mechanism 2 through which the stand style rear lens cap engages with the detachable lens according to the present invention; FIG. 5 is a schematic structural view illustrating a mode a of a mechanism 3 through which the stand style rear lens cap engages with the detachable lens according to the present invention;

FIG. 6 is a schematic structural view illustrating a mode b of a mechanism 3 through which the stand style rear lens cap engages with the detachable lens according to the present invention;

FIG. 7 is a schematic structural view of an embodiment of the mode b of the mechanism 3 shown in FIG. 6;

FIG. 8 is a schematic structural view of a stand style rear lens cap having an adjustable length mechanism;

FIG. 9 is a top view illustrating relative positions when a detachable lens having a thin lens body and a detachable lens having a fat lens body are placed corresponding to an edge of the stand style rear lens cap according to the present invention respectively;

FIG. 10 is a side view illustrating arc-shaped modifications for a vertically placed stand style rear lens cap structure of the present invention;

FIG. 11 is a schematic view illustrating a structure of a vertically placed flip-up stand style rear lens cap of the present invention;

FIGS. 12 and 13 are schematic views illustrating how to place into and remove from the vertically placed flip-up stand style rear lens cap for a detachable lens in a camera backpack respectively according to the present invention;

FIG. 14 is a schematic view illustrating another structure of the vertically placed flip-up stand style rear lens cap of the present invention; and

FIGS. 15 and 16 are schematic views illustrating that the stand style rear lens cap and the detachable lens are placed in a camera backpack and fixed by a Velcro tape according to the present invention.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

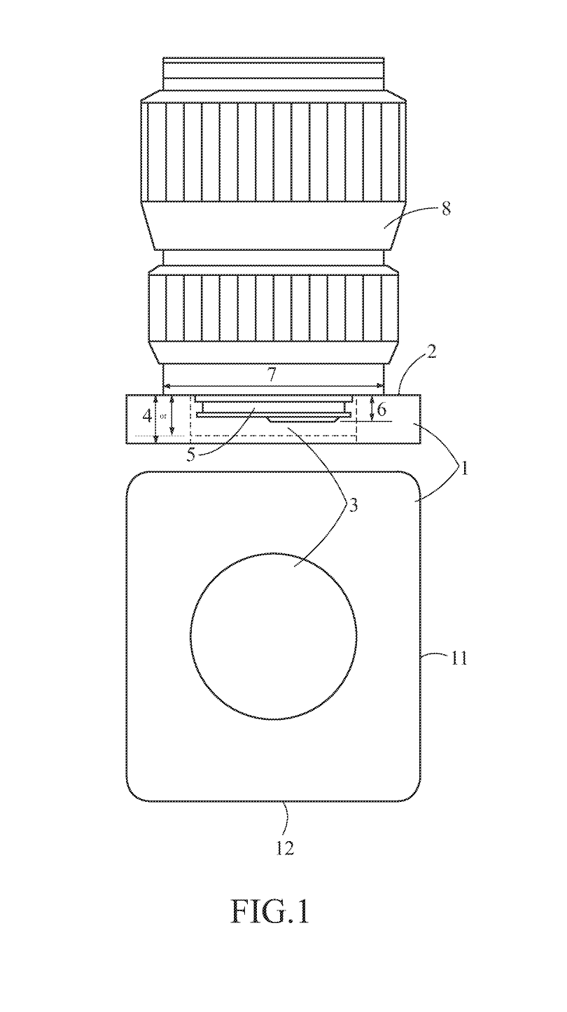

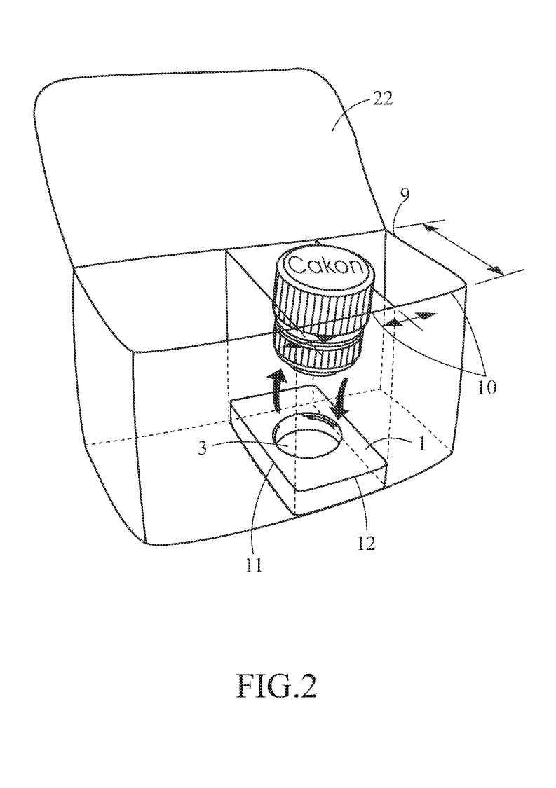

As shown in FIG. 1, in order to achieve the aforesaid concept of integrating the rear lens cap and the stand together, the stand style rear lens cap of the present invention comprises a stand body 1 that is higher than a rear-end projection 5 of a detachable lens 8 (i.e., an interface structure for the detachable lens 8 to engage with the camera body). The stand body 1 may have an edge of any form, and an upper end thereof shall provide a horizontal plane 2. Referring to FIG. 2 together, in a preferred implementation of the present invention, the stand body 1 may be formed as a square platform to match the shape of a camera backpack 22 so that the stand body 1 can be placed into and fixed at the bottom of a partition of the camera backpack 22.

As shown in FIG. 2, an internal partition of a general camera backpack 22 usually has a fixed first width 9 and an adjustable second width 10, so at least one of a fixed first side 11 and a variable second side 12 of the stand body 1 is equal in size to or slightly larger than the fixed first width 9 of the internal partition of the backpack to facilitate the fixation. The other one of the fixed first side 11 and the variable second side 12 is preferably sized according to the maximum diameter of the lens body so that the space occupied in the backpack is the smallest.

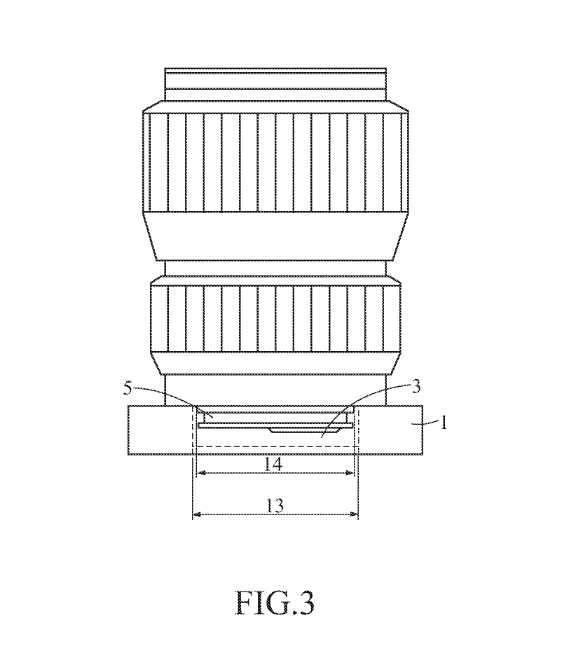

Referring back to FIG. 1, the horizontal plane 2 at the upper end of the stand body 1 is formed, at the center thereof, with a central opening 3 for the rear-end projection 5 to pass therethrough, and the size of the rear-end projection 5 varies with the camera system and specifications of different manufacturers. A first diameter 13 (shown in FIG. 3) of the central opening 3 is smaller than a second diameter 7 (shown in FIG. 1) of a lens body distal end, and a first depth 4 of the central opening 3 is larger than or at least equal to a maximum height 6 of the rear-end projection 5. In this way, the detachable lens 8 can stably stands on the stand body 1 (because, for most of rear-end projections 5, some part of the bottommost structure thereof is not on the same plane as of the other parts, so this part must be suspended in order for the detachable lens 8 to stand stably).

It shall be appreciated that wherever the stand body 1 is used, in a backpack or in other places such as in a moisture buster cabinet or on a desktop etc., the bottom of the stand body 1 will necessarily make close touch with a plane to make the other end of the central opening 3 closed, so the other end of the central opening 3 of the stand body 1 being closed (i.e., the central opening 3 is in the form of a recessed portion) or being open both fall within the scope of implementations of the stand body 1.

The engaging mechanisms between the stand body 1 and the detachable lens 8 and implementations thereof will be described as follows.

The first implementation (Mechanism 1):

As shown in FIG. 3, the detachable lens 8 simply passes through the central opening 3 and loosely stands on the stand body 1 without real engagement between the detachable lens 8 and the stand body 1.

The way to achieve this: by making a first diameter 13 of the central opening 3 slightly larger than an outer diameter 14 of the rear-end projection 5, the detachable lens 8 can engage with the stand body 1 loosely (not tightly) without any resistance. This way allows the detachable lens 8 to be removed and placed back the most quickly.

Applicability: at this point, the stand body 1 may be viewed as a table for temporarily storing the detachable lens 8 which has been detached, so the user can place this kind of stand body 1 in one of partitions of the backpack for purpose of quickly replacing the detachable lens 8.

Advantages: it is very easy to place the detachable lens 8 that has been detached into the stand body 1, and the time taken to replace the detachable lens 8 is the shortest.

Disadvantages: there is no real engagement between the detachable lens 8 and the stand body 1, so turn-over of the detachable lens 8 might be caused in case that a swing of backpack exceeding a certain level takes place. However, the turn-over will not cause damage to the detachable lens 8 in a backpack but only add to the risk of staining the rear lens due to exposure to the outside.

The second implementation (Mechanism 2):

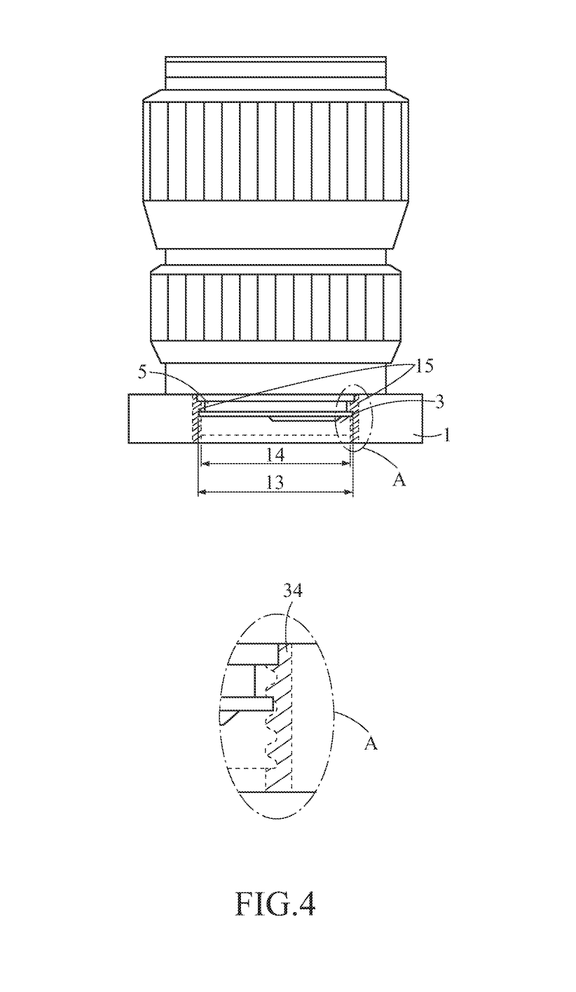

As shown in FIG. 4, the inner wall of the central opening 3 is provided with a component which allows the detachable lens 8 to engage with the stand body 1 tightly without swing.

The way to achieve this: one way is to dispose an elastic material 15 on the inner wall of the central opening 3 and to make the diameter 13 of the central opening 3 slightly smaller than the outer diameter 14 of the rear-end projection 5. Then when the detachable lens 8 engages with the stand body 1, the rear-end projection 5 will compress the elastic material 15 (e.g., rubber, foam or the like) disposed on the inner wall of the central opening 3 so that the detachable lens 8 is fixed to the stand body 1 tightly and securely without any swing.

As shown in FIG. 4, the elastic material 15 may be formed with a plurality of grooves 34 or nicks to increase the frictional force so that the detachable lens 8 tightly engages with the stand body 1 at an increased force level.

It shall be noted that, because the outer diameter 14 of the rear-end projection 5 of the detachable lens 8 varies with the manufacturers, the inner wall and the elastic material 15 can be fabricated correspondingly to make the diameter 13 of the central opening 5 of the stand body 1 slightly smaller than the outer diameter 14 of the rear-end projection 5 of the detachable lens 8 of the corresponding manufacturer.

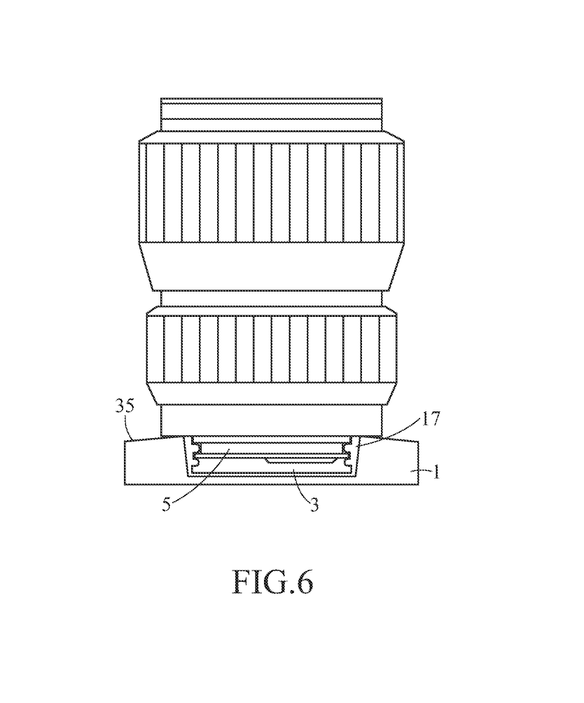

Of course, another way as shown in FIG. 7 may also be adopted as follows: with reference to an outer diameter 14 of the largest rear-end projection 5 that can be found in the market, a central opening 3 of a fixed size is firstly formed in the stand body 1 so that a rear lens cap joint ferrule 18 that is replaceable can be embedded therein, and another central opening is formed in the rear lens cap joint ferrule 18 and an elastic material 15 (or an inner wall made of an elastic material and formed with grooves 34) is also formed on the inner wall of the central opening. In this way, also as shown in FIG. 7, a diameter 21 of the central opening of the rear lens cap joint ferrule 18 will be slightly smaller than the outer diameter 14 of rear-end projections 5 of various manufacturers so that this structure can be applied to lenses of different manufacturers. A lateral recessed structure 19 of the rear lens cap joint ferrule 18 cooperates with an internal protrusion structure 20 of the central opening 3 of the stand body 1 to achieve the purpose of engagement and fixation.

Applicability: this is more applicable to detachable lenses 8 that is more lightweight and shorter, and it is less likely to cause loose of the stand body 1 due to swing; and for detachable lenses 8 that are heavier and longer, the engagement mechanism 3 described below is more applicable.

Advantages: it also allows for removing and placing back the detachable lens 8 quickly and easily, and the detachable lens 8 will not swing after being placed back. The detachable lens 8 will not disengage from the stand body 1 under normal conditions unless it is deliberately swung violently, e.g., when used in a backpack.

Disadvantages: as compared with the engagement mechanism 1 through which the detachable lens 8 can be removed and placed back the most easily, a pressing action is additionally needed in the process of placing back the detachable lens 8 and the frictional force generated partially due to compression of the inner wall must be overcome when the detachable lens 8 is to be removed. However, the detachable lens 8 can still be replaced very quickly and easily. Of course, it is still possible that the detachable lens 8 becomes loose in case of a violent swing.

The third implementation (Mechanism 3, Mode a):

As shown in FIG. 5, a thread portion 16 identical to that of the conventional rear lens cap is disposed at an inner side of the central opening 3 to lock the detachable lens 8 and fix the detachable lens 8 to the stand body 1.

Mode a: as shown in FIG. 5, the thread portion 16 is produced directly on the inner wall of the central opening 3 of the stand body 1.

Applicability: because the size of the rear lens interface and the thread structure vary with different manufacturers, it is only applicable to specific lenses of manufacturers conforming to this thread and size specification.

Advantages: as being locked by the thread, the detachable lens 8 can be fixed to and engage with the stand body 1 absolutely even in case of a violent swing or when a backpack carrying a too heavy and too long detachable lens 8 drops out, so this mode is applicable to various conditions.

Disadvantages: as compared with the engagement mechanism 1 through which the detachable lens 8 can be removed and placed back the most easily, a screwing or unscrewing action is additionally needed when placing back or removing the detachable lens 8, respectively, and the detachable lens 8 can be placed in only when the lens body is aligned at a proper angle. It shall be noted that, these additional actions have little influence on the overall operations.

The fourth implementation (Mechanism 3, Mode b):

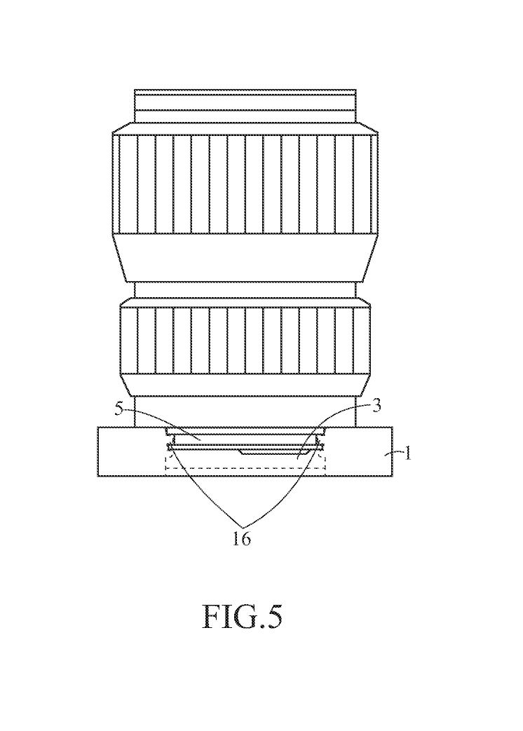

Mode b: a conventional rear lens cap 17 from a manufacturer is obtained and directly used to engage with the central opening 3 of the stand body 1. That is, as shown in FIG. 6, the central opening 3 of the stand body 1 is used as a receiver for receiving the conventional rear lens cap 17, and after the rear lens cap 17 engages with the stand body 1, an effect equivalent to that of Mode a is obtained.

This mode makes it easier to place the detachable lens 8 into the conventional rear lens cover 17 to engage therewith, and the horizontal plane 2 of the stand body 1 can be inclined slightly from a periphery of the central opening 3 towards the four edges to form an inclined portion 35.

Applicability: because even for cameras of the same specifications (e.g., 135 cameras), the outer diameter and the depth of the conventional rear lens cap 17 may also vary with different manufacturers, it is impossible for the stand body 1 having an invariable central opening 3 to accommodate different rear lens caps. Therefore, the central opening 3 of the stand body 1 can only be used with a conventional rear lens cap 17 of a specific size of different manufacturers and directly bonded to the conventional rear lens cap 17.

Advantages: like the mode a described above, locking with the thread allows the detachable lens 8 to be fixed to and engage with the stand body 1 absolutely even in case of a violent swing or when a backpack carrying a too heavy and too long detachable lens 8 drops out, so this mode is applicable to various conditions.

Disadvantages: like the mode a described above, as compared with the engagement mechanism 1 through which the detachable lens 8 can be removed and placed back the most easily, a screwing or unscrewing action is additionally needed when placing back or removing the detachable lens 8, respectively, and the detachable lens 8 can be placed in only when the lens body is aligned at a proper angle.

Other examples in use are described as follows:

1. Taking a camera backpack for the most commonly used 135 system SLRs as an example, the maximum lens body diameter of the detachable lens 8 commonly used is generally about 80 mm or slightly greater, so the length of the fixed first width 9 of the partition in the backpack is mostly about 80˜90 mm, and the length of the first side 11 of the stand body 1 is also desirably determined to be the same length as that of the fixed first width 9 or slightly greater so that compressible foam plates can be inserted to abut against an inner wall of the backpack to exactly fix the lens.

The length of the second side 12 of the stand body 1 (i.e., corresponding to the length of the adjustable second width 10 of the backpack) is desirably close to the minimum lens body diameter of commonly used detachable lenses 8. Then, no matter whether the detachable lens 8 to be placed has a large or a small diameter, an adjustable partitioning plate 24 of the camera backpack can always be moved to the optimal position so that the stand body 1 can be kept stationary during the operation, thus making full use of the space in the backpack. For example, the smallest diameter of the lens body the commonly used 135 cameras is on the order of 60 mm and close to 70 mm, so the integer of 70 mm may be selected as the length of this side.

For camera backpacks of other camera systems (e.g., micro 4/3 camera systems), the principle is also the same as long as the specifications and the sizes are modified correspondingly.

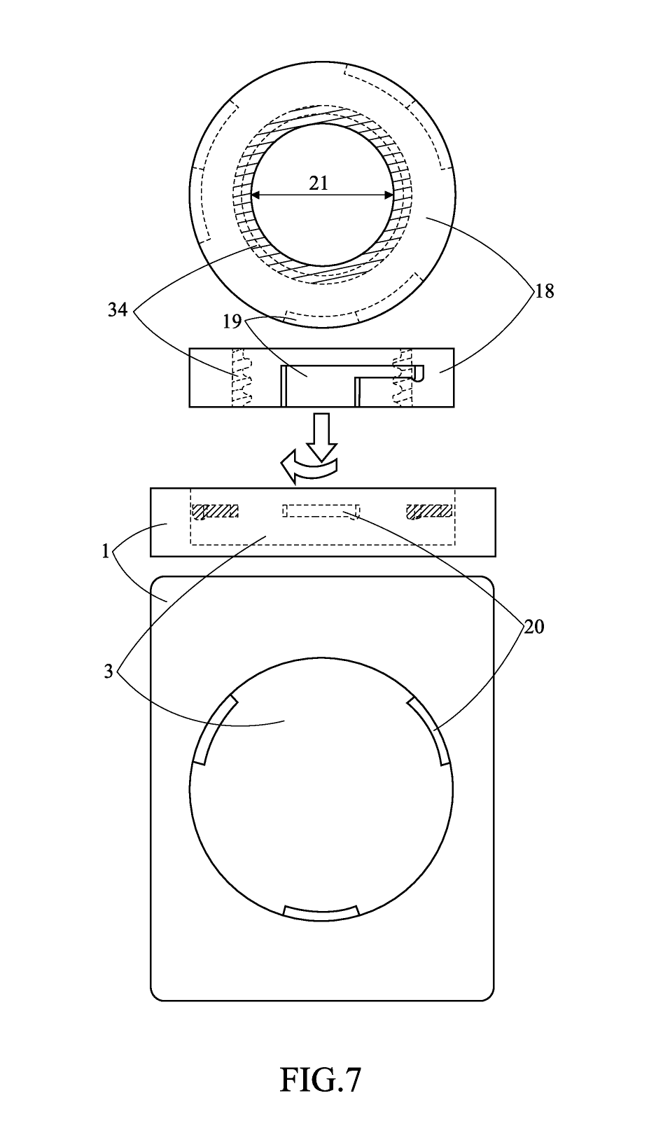

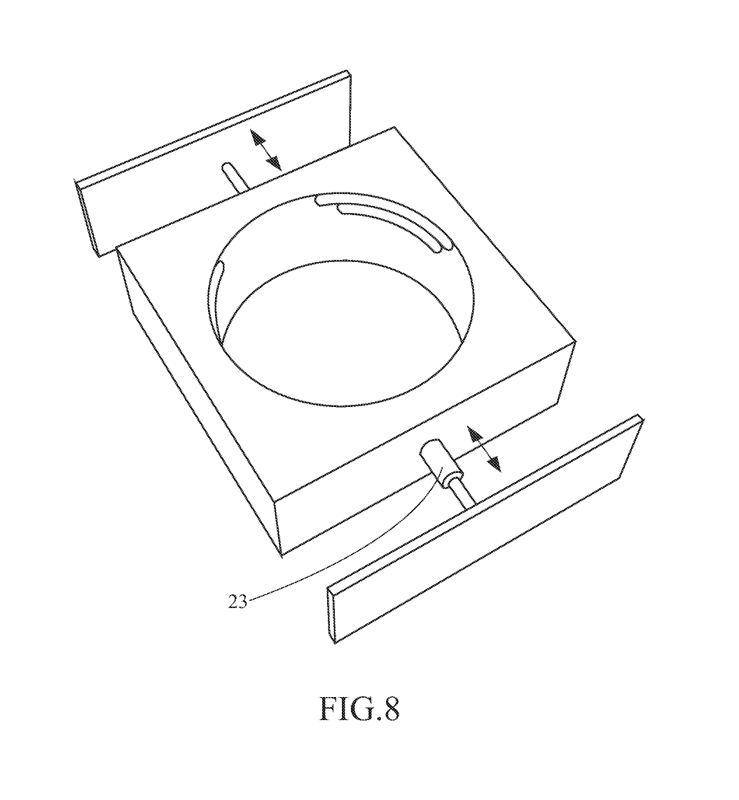

2. There are various kinds of camera backpacks in the market, and even for a same kind of camera backpacks, it is still possible that the length of the fixed width side of the partitions of some of the backpacks is significantly different from the common standard length. To ensure that the stand body 1 can be placed in and be fixed to abut against the inner wall of the partition, as shown in FIG. 8, the stand body 1 could be designed to have a adjustable length mechanism 23 at each of the two opposite sides respectively, and each of the adjustable length mechanisms 23 is used to extend to connect with a baffle 23a so as to be fixed against the internal partitioning plate 32. Further, the adjustable length mechanism 23 may be implemented by any similar conventional mechanisms.

3. For some detachable lenses 8 having a long lens body, the length thereof may exceed the depth of the partition of the backpack, so the user often has to place the lens in a horizontal direction by removing some of the adjustable partitioning plates 24 of the camera backpack. In this case, there may be two ways to use the stand style rear lens cap of the present invention.

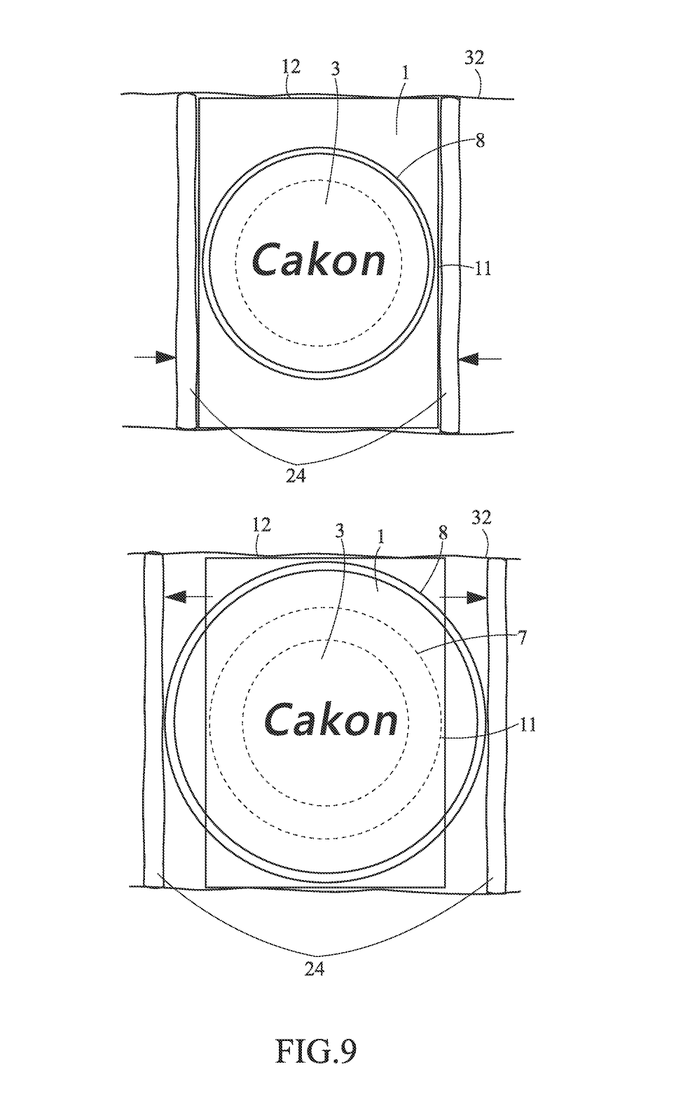

Mode a: the stand body 1 needs to be rotated in the vertical direction when the detachable lens 8 that is placed horizontally is removed, so corners of the stand body 1 are modified into an arc shape to facilitate this operation, as shown in FIG. 10.

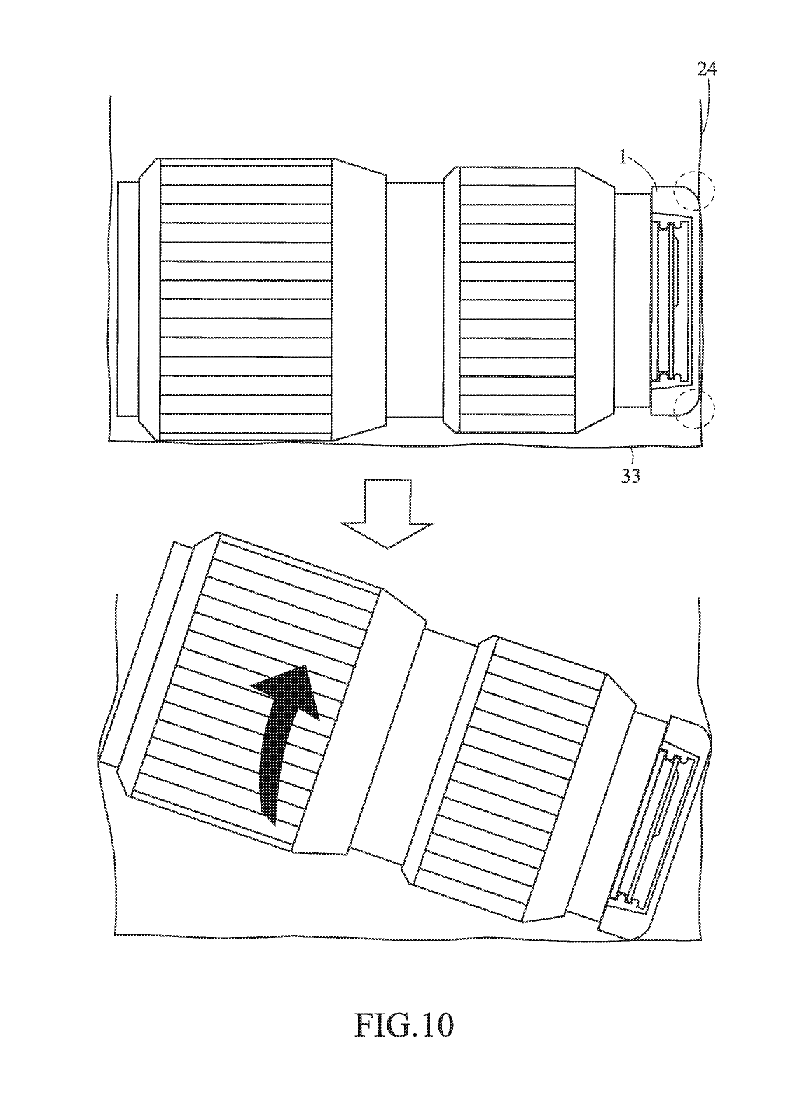

Mode b: the detachable lens 8 is designed to be removed and placed through a flip-up opening. As shown in FIG. 11, a lateral portion of the stand body 1 is formed as a flip-up cover 25 that can be opened so that the detachable lens 8 can be directly removed or placed in through the opening. When the opening is closed, the two parts can be joined securely together by means of a Velcro tape 30 to form the complete stand body 1 again. Furthermore, the stand body 1 has a flip-up pull-tab 26 disposed on the flip-up cover 25 to facilitate opening of the flip-up cover 25 by the user. The flip-up cover 25 is pivotally fixed to the body portion of the stand body 1 via a pivoting portion formed by a plurality of shafts 28 and an axle 29, and has a fixing tenon 27 at a side opposite to the flip-up pull-tab 26.

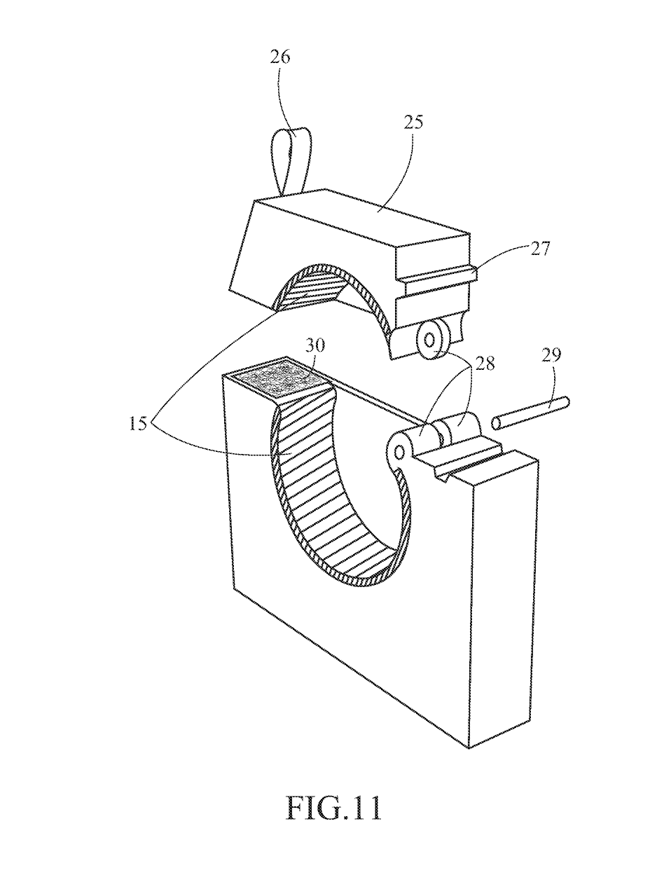

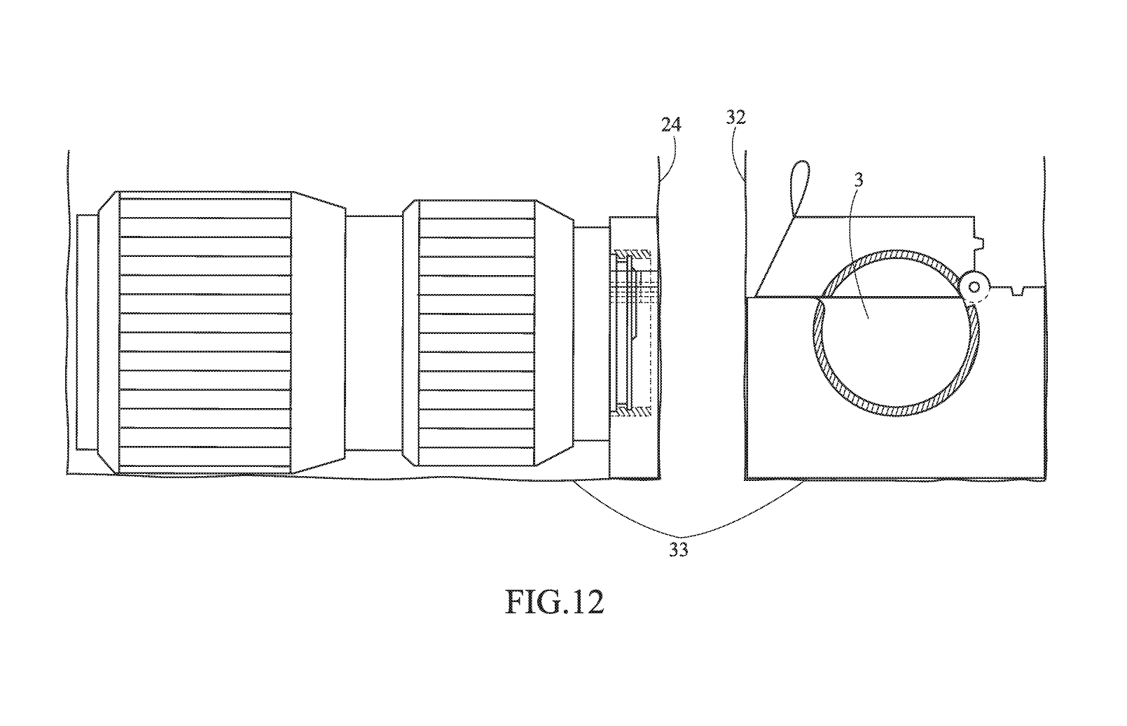

When operating, as shown in FIG. 12, both the bottom and the periphery of the stand body 1 are fixed with respect to the internal partitioning plate 32 of the camera backpack; and as shown in FIG. 13, when the flip-up cover 25 is lifted by means of the flip-up pull-tab 26 to vertically remove, place or fix the detachable lens 8, the flip-up cover 25 is fixed by the fixing tenon 27 to the body portion of the stand body 1 so as to prevent damage to the detachable lens 8 due to a sudden fall.

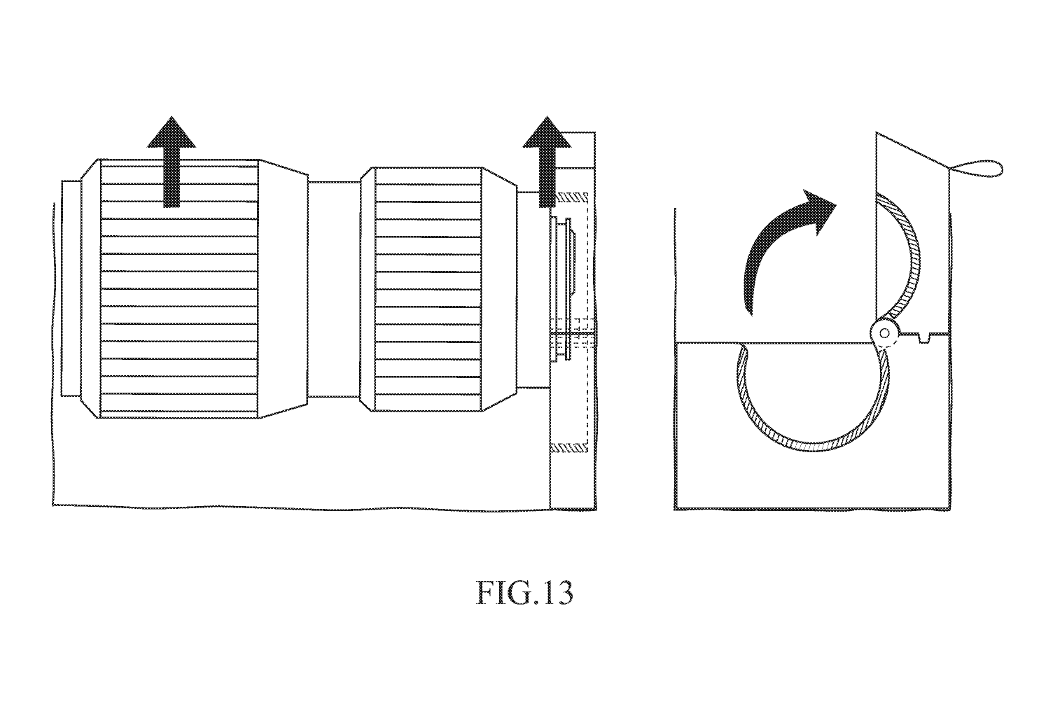

As shown in FIG. 14, the flip-up cover 25 may also be pivotally joined to the body portion of the stand body 1 via a pivoting portion formed by a flexible planar shaft 31 in replace of the complex structure formed by the plurality of shafts 28 and the axle 29 described in the embodiment of FIG. 11.

In the aforesaid embodiment of the stand body 1 where the detachable lens 8 is detached or fixed from the lateral side, it is impossible for the rear-end projection 5 of the detachable lens 8 and the inner wall of the central opening 3 to engage with each other by means of threads, so an elastic material 15 having an inner diameter slightly smaller than the outer diameter of the rear-end projection 5 is adopted to assist in fixing the lens through compression and friction. Similar to what described previously in the second implementation (Mechanism 2): the elastic material 15 may be formed with a plurality of grooves 34 or nicks as shown in FIG. 4 to increase the frictional force so that the detachable lens 8 tightly engages with the stand body 1 at an increased force level.

Preferably, the flip-up stand body is made of a hard expanded foam because the slight expansion and contraction property of the hard expanded foam can allow the end of the lens to be inserted through the lateral opening of the stand body 1 that has a size smaller than the outer diameter 14 of the rear-end projection 5 of the lens.

4. Because the body portion of the stand body 1 often has to be carried in the backpack and shall be fixed to keep stationary at the bottom of the backpack, it is preferably made of a lightweight and rigid material, e.g., Styrofoam, a hard expanded material, a lightweight wood material or a hollow hard plastic injection molded.

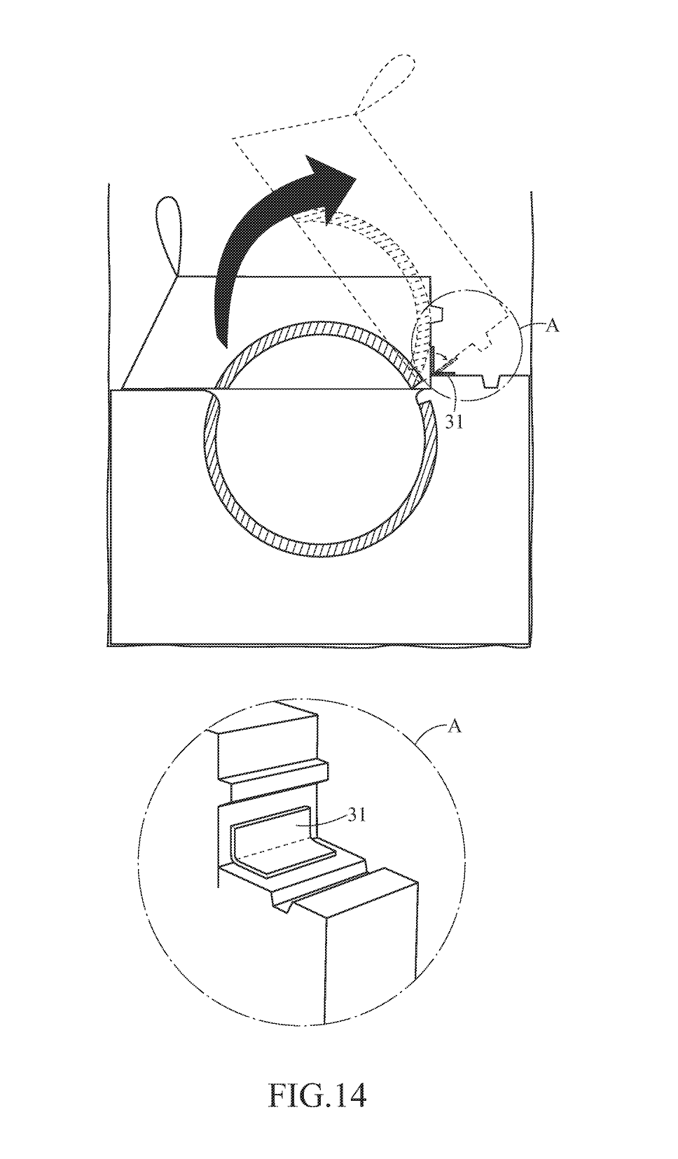

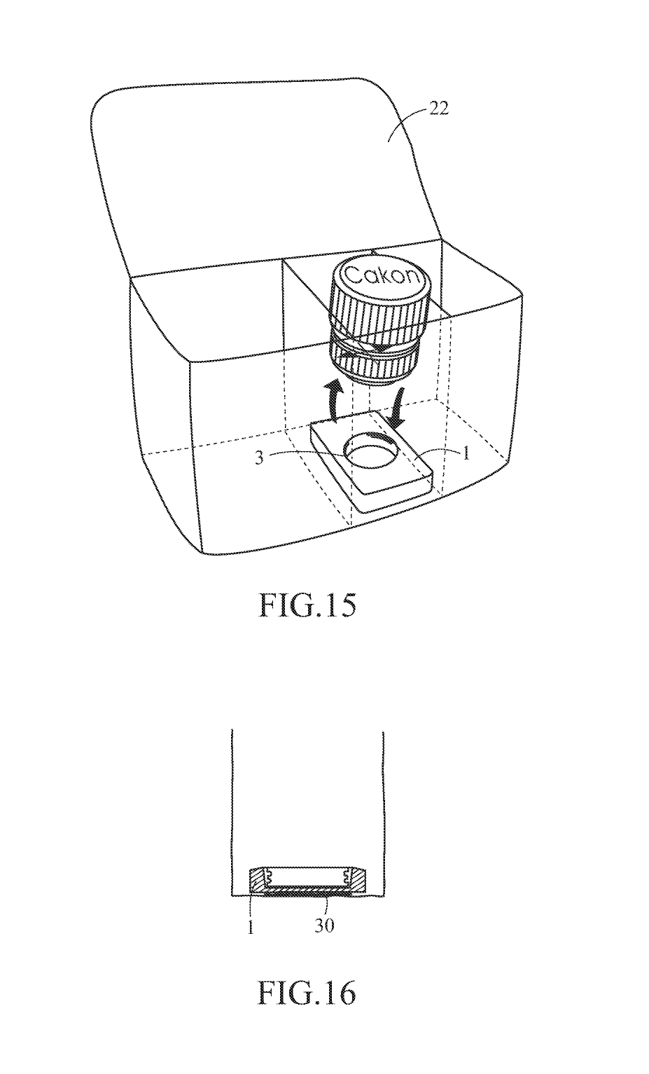

5. The embodiments discussed above are the simplest designs that can be achieved by the present invention, and there are also other alternative designs that can achieve the same effect. As shown in FIGS. 15 and 16, when the fixed length side 11 and the variable length side 12 of the stand body 1 both have lengths smaller than the corresponding widths of the partition of the camera backpack 22 and, thus, the stand body 1 cannot be fixed to the bottom 33 of the camera backpack by means of the closely matching lengths, other conventional technologies for bonding objects may be adopted (e.g., the simplest and the most commonly used way is to use the Velcro tape 30) so that the stand body 1 can still be bonded and fixed to the bottom 33 of the camera backpack. However, the camera backpacks currently available in the market all have a foam covered by a layer of water-proof cloth at the bottom 33 of the camera backpack for purpose of cushioning and protecting the camera and the lens. Therefore, even if a Velcro tape 30 is additionally disposed at both the bottom of the stand body 1 and the bottom 33 of the camera backpack to bond two together, the Velcro tape 30 will be bonded to only the waterproof cloth. This might cause a loose bonding rather than a real, complete and effective fixation of the stand body 1 to the bottom 3 of the camera backpack. Further, it is also difficult to accurately center the central opening to facilitate proper placement of the lens when the position is changed due to use of a lens with a different diameter size of body. This can be solved by changing the structural design of the bottom 33 of the camera backpack and enlarging the boding area between the Velcor tape 30 and the stand body 1. Nevertheless, the stability level obtained by bonding with the Velcro tape 30 is still lower than that of the aforesaid embodiment where the fixation is achieved by means of the matching lengths. However, this is still a feasible alternative implementation.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A stand style rear lens cap for use in a detachable lens of a camera, comprising:
a stand body, an upper end of the stand body having a horizontal plane, and the horizontal plane having a central opening adapted for a rear-end projection of the detachable lens to pass therethrough;
wherein a first diameter of the central opening is smaller than a second diameter of a lens body distal end of the detachable lens, a first depth of the central opening is larger than or equal to a height of the rear-end projection of the detachable lens, and an inner wall of the central opening is provided with a component that correspondingly engages with the rear-end projection of the detachable lens.

2. The stand style rear lens cap as claimed in claim 1, wherein the component of the inner wall of the central opening that correspondingly engages with the rear-end projection of the detachable lens is made of an elastic material, and the first diameter of the central opening is smaller than an outer diameter of the rear-end projection of the detachable lens.

3. The stand style rear lens cap as claimed in claim 1, wherein the component of the inner wall of the central opening that correspondingly engages with the rear-end projection of the detachable lens is a thread that correspondingly engages with the rear-end projection of the detachable lens, and an inner diameter of the central opening is identical to an inner diameter of an opening of a rear lens cap of the detachable lens.

4. The stand style rear lens cap as claimed in claim 1, wherein the inner wall of the central opening is adapted to embed a rear lens cap of the detachable lens therein so that, after the rear-end projection of the detachable lens passes through the central opening, the rear-end projection of the detachable lens correspondingly engages with the rear lens cover.

5. The stand style rear lens cap as claimed in claim 1, wherein a lateral side length of the stand body is equal to or larger than a fixed width of an inner partition of a camera backpack.

6. The stand style rear lens cap as claimed in claim 1, wherein the first diameter of the central opening is not larger than an outer diameter of a rear lens cap of the detachable lens.

7. The stand style rear lens cap as claimed in claim 1, wherein two opposite sides of the stand body are each provided with a variable length mechanism used to extend to connect with a baffle.

8. The stand style rear lens cap as claimed in claim 1, wherein the central opening is adapted to extend through a bottom of the stand body.

9. The stand style rear lens cap as claimed in claim 1, wherein the central opening is a recessed portion formed in the stand body.

10. The stand style rear lens cap as claimed in claim 1, wherein the stand body is adapted to be cut into a first portion and a second portion along a direction perpendicular to the horizontal plane, and the first portion and the second portion are adapted to be pivotally joined together via a pivoting portion.

11. The stand style rear lens cap as claimed in claim 1, wherein the stand body has a simple detach-and-attach device at the bottom thereof, which is adapted to engage with a corresponding device located at a bottom of an internal partition space of a camera backpack.

12. The stand style rear lens cap as claimed in claim 11, wherein the simple detach-and-attach device is a Velcro tape.

13. The stand style rear lens cap as claimed in claim 1, wherein the first diameter of the central opening is adapted to accommodate a smaller stand having a second central opening, a lateral side of an outer edge of the smaller stand is provided with a tenon structure adapted to corresponding engage with a corresponding structure of the first diameter of the central opening, and an inner wall of the second central opening of the smaller stand is provided with a component adapted to corresponding engage with the rear-end projection of the detachable lens.
